(19) United States
(12) Patent Application Publication
(10) Pub. No.: US 2025/0162421 A1
(43) Pub. Date: May 22, 2025

(54) MOBILE OBJECT CONTROL DEVICE, MOBILE OBJECT CONTROL METHOD, AND NON-TRANSITORY COMPUTER-READABLE STORAGE MEDIUM INCLUDING MOBILE OBJECT CONTROL PROGRAM

(71) Applicant: DENSO CORPORATION, Kariya-city (JP)

(72) Inventors: Hirofumi KAKO, Kariya-city (JP); Ryuji OMATA, Kariya-city (JP)

(21) Appl. No.: 19/028,876

(22) Filed: Jan. 17, 2025

Related U.S. Application Data
(63) Continuation of application No. PCT/JP2023/027820, filed on Jul. 28, 2023.

(30) Foreign Application Priority Data
Sep. 30, 2022 (JP) 2022-158841

(51) Int. Cl. B60L 1/00; B60R 16/023

(52) U.S. Cl. CPC B60L 1/003; B60R 16/0238; B60L 2210/10

(57) ABSTRACT

A mobile object control device includes a controller. The controller is configured to receive an instruction to execute an installation or activation of a power converter program for controlling a power converter that is installed in a mobile object, execute the installation or activation of the power converter program based on the instruction when input voltage is not applied to an electric device that is driven by the power converter, and stop power supply to the electric device and then execute the installation or activation of the power converter program based on the instruction when the input voltage is applied to the electric device.

### CROSS REFERENCE TO RELATED APPLICATION

The present application is a continuation application of International Patent Application No. PCT/JP2023/027820 filed on Jul. 28, 2023, which designated the U.S. and claims the benefit of priority from Japanese Patent Application No. 2022-158841 filed on Sep. 30, 2022. The entire disclosures of all the above applications are incorporated herein by reference.

### TECHNICAL FIELD

The present disclosure relates to a mobile object control device, a mobile object control method, and a mobile object control program.

### BACKGROUND

There is a vehicle controller that controls a vehicle. The vehicle control executing unit of the vehicle controller changes a control state of the vehicle for not executing control processing using vehicle control software together with rewrite processing of the vehicle control software.

### SUMMARY

According to one aspect of the present disclosure, a mobile object control device includes a controller. The controller is configured to execute an installation and activation of a power converter program for controlling a power converter that is installed in a mobile object. The controller is configured to execute the installation or activation of the power converter program in a state where input voltage is not applied to an electric device that is driven by the power converter.

According to the second aspect of the present disclosure, a mobile object control method executed by at least one processor is provided. The mobile object control method includes executing an installation or activation of a power converter program for controlling a power converter that is installed in a mobile object in a state where input voltage is not applied to an electric device that is driven by the power converter.

According to the third aspect of the present disclosure, a mobile object control program for installing or activation a power converter program for a power converter in a mobile object is provided. The mobile object control program is configured to cause at least one processor to execute an installation or activation of the power converter program in a state where input voltage is not applied to an electric device that is driven by the power converter.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram showing the configuration of a vehicle control system according to a first embodiment;

FIG. 2 is a diagram showing the hardware configuration of a vehicle control ECU according to the first embodiment;

FIG. 3 is a flowchart of a vehicle control process according to the first embodiment;

FIG. 4 is a flowchart of a modified example of the vehicle control process according to the first embodiment;

FIG. 5 is a diagram showing the configuration of a vehicle control system according to a second embodiment; and

FIG. 6 is a flowchart of a vehicle control process according to the second embodiment.

### DETAILED DESCRIPTION OF THE PREFERRED EMBODIMENTS

To begin with, examples of relevant techniques will be described.

There is a vehicle controller that controls a vehicle. The vehicle controller includes a storage device, a vehicle control executing unit, a rewrite processing unit, and a state determination unit. The storage device stores multiple types of vehicle control software for controlling the vehicle. The vehicle control executing unit executes control processing for the vehicle with the vehicle control software. The rewrite processing unit executes rewrite processing for a target software among the multiple types of vehicle control software based on a request to rewrite the vehicle control software. The state determination unit determines whether the control processing using the target software is to be executed together with the rewrite processing of the target software. The vehicle control executing unit changes a control state of the vehicle for not executing the control processing together with the rewrite processing when it is determined that the control processing is to be executed together with the rewrite processing.

For example, when installing or activating a power converter program for controlling a power converter that is mounted on a mobile object and drives a switching element, the switching element may operate unintentionally, resulting in unintentional power supply to an electric device driven by the power converter.

It is an objective of the present disclosure to provide a mobile object control device, a mobile object control method, and a mobile object control program that can prevent electric power from unintentionally being supplied to an electric device that is driven by a power converter.

According to one aspect of the present disclosure, a mobile object control device includes a controller. The controller is configured to execute an installation and activation of a power converter program for controlling a power converter that is installed in a mobile object. The controller is configured to execute the installation or activation of the power converter program in a state where input voltage is not applied to an electric device that is driven by the power converter.

According to the second aspect of the present disclosure, a mobile object control method executed by at least one processor is provided. The mobile object control method includes executing an installation or activation of a power converter program for controlling a power converter that is installed in a mobile object in a state where input voltage is not applied to an electric device that is driven by the power converter.

According to the third aspect of the present disclosure, a mobile object control program for installing or activation a power converter program for a power converter in a mobile object is provided. The mobile object control program is configured to cause at least one processor to execute an installation or activation of the power converter program in a state where input voltage is not applied to an electric device that is driven by the power converter.

According to the present disclosure, it is possible to suppress unintended power supply to an electric device driven by a power converter.

Hereinafter, embodiments for implementing the present disclosure will be described with reference to the drawings.

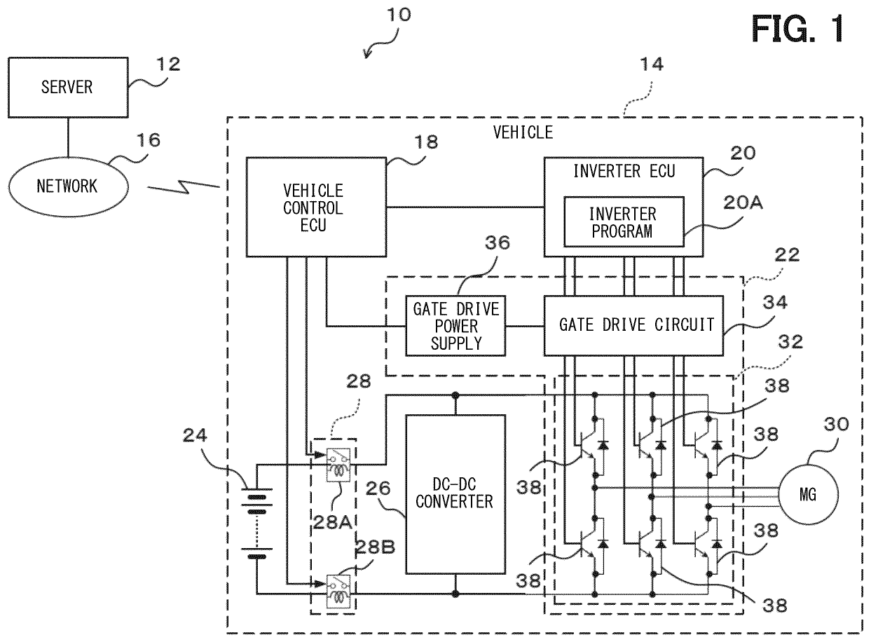

(First Embodiment) As shown in FIG. 1, a vehicle control system 10 of the present embodiment includes a server 12 and a vehicle 14. The server 12 and the vehicle 14 are connected via a network 16.

The vehicle 14 is equipped with a vehicle control Electronic Control Unit (ECU) 18, an inverter Electronic Control Unit (ECU) 20, an inverter 22, a drive battery 24, a DC-DC converter 26, a relay unit 28, and a motor generator 30. The vehicle 14 is an example of a mobile object according to the present disclosure. The vehicle control ECU 18 is an example of a mobile object control device according to the present disclosure. Moreover, the motor generator 30 is an example of an electric device according to the present disclosure. Moreover, the inverter 22 is an example of a power converter according to the present disclosure.

The vehicle control ECU 18 controls the inverter 22 and the relay unit 28. Furthermore, the vehicle control ECU 18 acquires an inverter program 20A to be executed by the inverter ECU 20 from the server 12 via the network 16, and instructs the inverter ECU 20 to install or activate the acquired inverter program 20A. Here, the installation of the inverter program 20A means storing the inverter program 20A in a non-volatile memory (not shown) of the inverter ECU 20 so that the inverter program 20A can be executed. Moreover, the activation of the inverter program 20A means enabling functions by execution of the inverter program 20A. The inverter program 20A is an example of a power converter program.

The inverter ECU 20 controls the inverter 22 by executing the inverter program 20A that has been installed or activated.

The inverter 22 includes a switching circuit 32, a gate drive circuit 34, and a gate drive power supply 36. The gate drive circuit 34 is an example of a drive circuit of the present disclosure.

The switching circuit 32 includes multiple switching elements 38. In the present embodiment, the switching circuit 32 includes, as an example, six switching elements 38. As the switching elements 38, for example, Insulated Gate Bipolar Transistor (IGBT) may be adopted, but the switching elements 38 are not limited thereto.

The gate drive circuit 34 turns on or off each of the multiple switching elements 38 in response to instructions from the inverter ECU 20. As a result, drive voltage for driving the motor generator 30 is output from the switching circuit 32, and the motor generator 30 is driven.

The gate drive power supply 36 supplies power to the gate drive circuit 34 in response to an instruction from the vehicle control ECU 18.

The drive battery 24 is a power source that supplies DC voltage for driving electric devices mounted on the vehicle 14, such as the motor generator 30. The drive battery 24 is charged with electric power generated by a generator driven by the driving force of an engine (not shown), for example.

The relay unit 28 is connected to the drive battery 24. The relay unit 28 includes a relay 28A connected to the positive terminal of the drive battery 24 and a relay 28B connected to the negative terminal of the drive battery 24.

The vehicle control ECU 18 controls on and off of the relays 28A, 28B. When the vehicle control ECU 18 turns on the relays 28A and 28B, DC voltage is applied from the drive battery 24 to the DC-DC converter 26. On the other hand, when the vehicle control ECU 18 turns off the relays 28A and 28B, no DC voltage is applied from the drive battery 24 to the DC-DC converter 26.

The DC-DC converter 26 converts the DC voltage applied from the drive battery 24 into predetermined DC voltage and supplies it to the switching circuit 32.

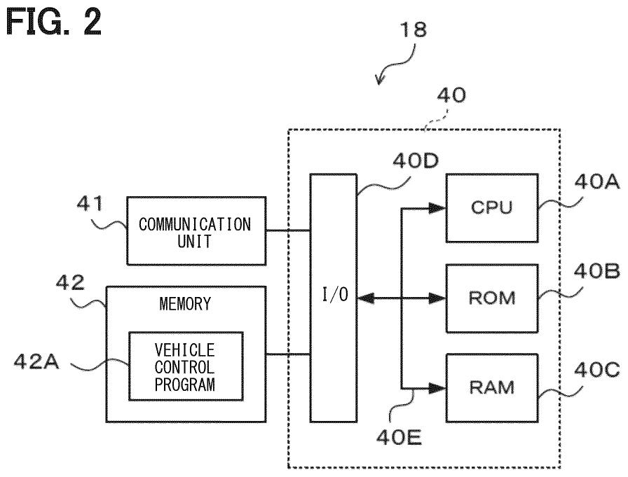

FIG. 2 is a block diagram showing the hardware configuration of the vehicle control ECU 18. As shown in FIG. 2, the vehicle control ECU 18 includes a controller 40.

As shown in FIG. 2, the controller 40 includes a Central Processing Unit (CPU) 40A, a Read Only Memory (ROM) 40B, a Random Access Memory (RAM) 40C, and an input/output interface (I/O) 40D. The CPU 40A, the ROM 40B, the RAM 40C, and the I/O 40D are connected to each other via a bus 40E. The bus 40E includes a control bus, an address bus, and a data bus. The I/O 40D is connected to a communication unit 41 and a memory 42. The CPU 40A is an example of a controller.

The communication unit 41 is an interface for performing data communication with external devices such as the server 12 and other ECUs of the vehicle 14 such as the inverter ECU 20.

The memory 42 is, for example, a non-volatile memory. As shown in FIG. 2, the memory 42 stores a vehicle control program 42A and the like. The vehicle control program 42A is an example of a mobile object control program of the present disclosure.

The CPU 40A is an example of a computer. The term “computer” here refers to a processor in a broad sense, and includes a general-purpose processor (e.g., a CPU) or a dedicated processor (e.g., a GPU: Graphics Processing Unit, an ASIC: Application Specific Integrated Circuit, an FPGA: Field Programmable Gate Array, a programmable logic device, etc.).

The vehicle control program 42A may be stored in a non-volatile and non-transitory storage medium or distributed via a network, and installed in the vehicle control ECU 18 as appropriate.

Examples of the non-volatile and non-transitory storage media include Compact Disc Read Only Memory (CD-ROMs), optical magnetic disks, hard disk drives (HDDs), Digital Versatile Disc Read Only Memory (DVD-ROMs), flash memory, memory cards.

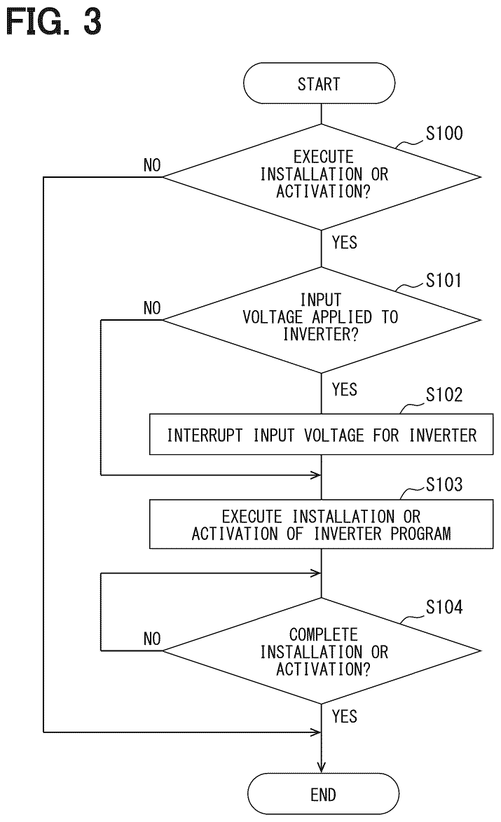

Next, a flow chart of a vehicle control process executed by the CPU 40A of the vehicle control ECU 18 will be described with reference to FIG. 3. The process in FIG. 3 is repeatedly executed.

In step S100, the CPU 40A determines whether to execute an installation or activation of the inverter program 20A. Whether to install the inverter program 20A is determined based on, for example, whether an instruction to update the inverter program 20A has been received from the server 12. Moreover, whether to activate the inverter program 20A is determined based on, for example, whether an instruction to activate the inverter program 20A has been received from the server 12.

If it is determined that the installation or activation of the inverter program 20A is to be executed, the process proceeds to step S101. On the other hand, if it is determined that neither the installation nor the activation of the inverter program 20A is to be executed, this routine ends.

In step S101, the CPU 40A determines whether input voltage is applied to the inverter 22, that is, whether the voltage from the drive battery 24 is applied to the input terminal of the switching circuit 32 of the inverter 22. Specifically, the CPU 40A determines whether the relays 28A, 28B are on. If the relays 28A, 28B are on, the CPU 40a determines that the input voltage is applied to the inverter 22, and if the relays 28A, 28B are off, the CPU 40a determines that the input voltage is not applied to the inverter 22.

If it is determined that the input voltage is applied to the inverter 22, the process proceeds to step S102, and if it is determined that the input voltage is not applied to the inverter 22, the process proceeds to step S103.

In step S102, the CPU 40A interrupts the input voltage to the inverter 22. Specifically, the CPU 40A turns off the relays 28A and 28B. As a result, the input voltage is not applied from the drive battery 24 to the inverter 22.

In step S103, the CPU 40A executes the installation or activation of the inverter program 20A. Specifically, when the installation of the inverter program 20A is determined in step S100, the CPU 40A obtains the inverter program 20A from the server 12 and causes the inverter ECU 20 to install the obtained inverter program 20A. Furthermore, when the activation of the inverter program 20A is determined in step S100, the CPU 40A causes the inverter ECU 20 to activate the inverter program 20A that has been already installed in the inverter ECU 20.

In step S104, the CPU 40A determines whether the installation or activation of the inverter program 20A has been completed. If the installation or activation of the inverter program 20A has not been completed, the process waits until it is completed, and if the installation or activation of the inverter program 20A has been completed, this routine ends.

In this manner, the installation or activation of the inverter program 20A is executed in a state where the input voltage is not applied to the inverter 22 in this embodiment. That is, the installation or activation of the inverter program 20A is executed in a state where the input voltage is not applied to the motor generator 30 that is driven by the inverter 22. This makes it possible to prevent the motor generator 30 from generating an unintended driving force.

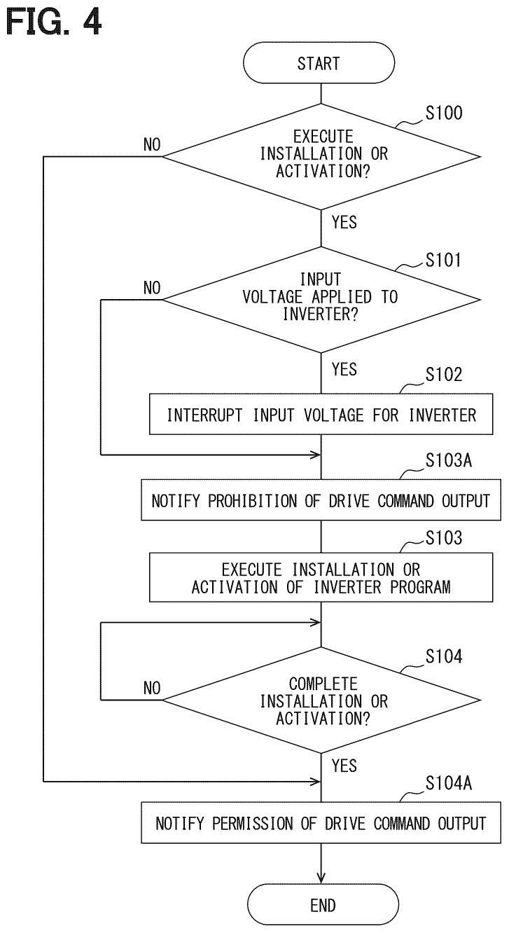

In the present embodiment, the process shown in FIG. 3 is described as being executed by the vehicle control ECU 18. However, the inverter ECU 20 may execute the process shown in FIG. 3. In this case, the inverter ECU 20 serves as the mobile object control device of the present disclosure. In this case, for example, in a configuration that the vehicle control ECU 18 as a higher-level controller outputs a drive instruction to the inverter ECU 20 and the inverter ECU 20 drives the inverter 22 upon receiving the drive instruction, the inverter 22 may be unintentionally driven when the vehicle control ECU 18 outputs a drive instruction to the inverter ECU 20 while the inverter program 20A is being installed or activated. Thus, as shown in FIG. 4, in step S103A before the installation or activation of the inverter program 20A in step S103, the vehicle control ECU 18 may be notified that the inverter ECU 20 cannot accept the drive instruction for the inverter 22. In addition, in step S104A after it is determined in step S104 that the installation or activation of the inverter program 20A is completed, the vehicle control ECU 18 may be notified of permission to output a drive instruction to the inverter 22.

(Second Embodiment) A second embodiment will be described. The same parts as those in the first embodiment are denoted by the same reference numerals, and detailed explanations thereof will be omitted.

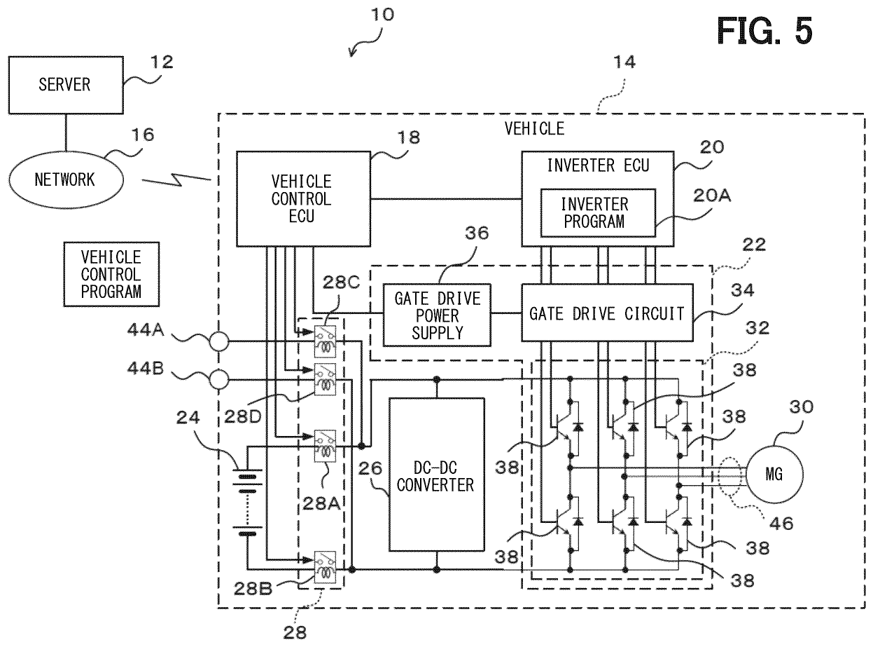

FIG. 5 shows the vehicle 14 according to the second embodiment. The vehicle 14 in the second embodiment differs from the vehicle 14 in the first embodiment in that the vehicle 14 of the second embodiment is provided with charging ports 44A and 44B to which an external power source (not shown) can be connected, and is configured so that the drive battery 24 can be charged from the external power source connected to the charging ports 44A and 44B, and in that the relay unit 28 is composed of four relays 28A, 28B, 28C, and 28D.

The relay 28C is connected between the charging port 44A and the relay 28A. The relay 28D is connected between the charging port 44B and the relay 28B.

The charging ports 44A and 44B are supplied with power, for example, for quick charging or normal charging from an external power source (not shown). The drive battery 24 is charged with power supplied to the charging ports 44A and 44B from the external power source (not shown). When charging the drive battery 24, the vehicle control ECU 18 turns on the relays 28A, 28B, 28C, and 28D. As a result, the drive battery 24 is charged with power supplied from the external power source (not shown).

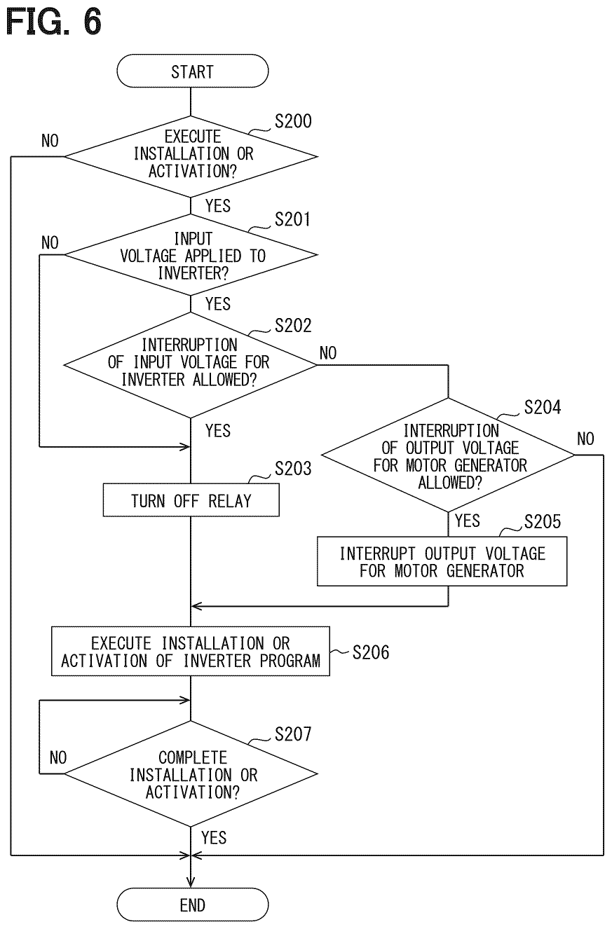

Next, a flow chart of a vehicle control process executed by the CPU 40A of the vehicle control ECU 18 shown in FIG. 6 will be described. It should be noted that the explanation of steps same as those in FIG. 3 will be omitted.

The processes in steps S200 and S201 are the same as those in steps S100 and S101 in FIG. 3, and therefore will not be described.

In step S202, the CPU 40A determines whether the input voltage applied to the inverter 22 can be interrupted. Here, examples of cases in which the input voltage to the inverter 22 can be interrupted include, but are not limited to, when the parking brake of the vehicle 14 is on, when the shift position is in parking, when the vehicle 14 is stopped and not in a running state, and when the charging mode is a normal charging mode.

If the input voltage to the inverter 22 can be interrupted, the process proceeds to step S203, and if the input voltage to the inverter 22 cannot be interrupted, the process proceeds to step S204.

In step S203, the CPU 40A turns off the relays 28A, 28B, 28C, and 28D. This interrupts the input voltage from the drive battery 24 to the inverter 22.

In step S204, the CPU 40A determines whether the output voltage to the motor generator 30 can be interrupted. Here, the example of the case where the output voltage to the motor generator 30 can be interrupted includes, but is not limited to, when the charging mode is a rapid charging mode.

If the output voltage to the motor generator 30 can be interrupted, the process proceeds to step S205, and if the output voltage to the motor generator 30 cannot be interrupted, the present routine ends.

In step S205, the CPU 40A interrupts the output voltage to the motor generator 30. Specifically, for example, the gate drive power supply 36 is turned off. As a result, the power supply to the gate drive circuit 34 is stopped. As a result, the gate drive circuit 34 cannot operate and the switching element cannot be driven. Thus, the input voltage to the gate of the switching circuit 32 is interrupted, and the output voltage to the motor generator 30 is interrupted.

Also, the inverter ECU 20 may be instructed to stop outputting a drive signal to the gate drive circuit 34. As a result, the output of the drive signal from the inverter ECU 20 is stopped and the gate drive circuit 34 becomes unable to operate, so that the input voltage to the gate of the switching circuit 32 is interrupted and the output voltage to the motor generator 30 is interrupted.

In addition, for example, the power supply via a power supply line 46 connecting the switching circuit 32 and the motor generator 30 may be configured to be interrupted. In this case, the output voltage to the motor generator 30 may be interrupted by interrupting the power path from the switching circuit 32 to the motor generator 30 to interrupt the power supply.

The processes in steps S206 and S207 are the same as those in steps S103 and S104 in FIG. 3, and therefore will not be described.

As described above, in this embodiment, the installation or activation of the inverter program 20A is executed in a state where output voltage is not output from the inverter 22 to the motor generator 30. This makes it possible to prevent the motor generator 30 driven by the inverter 22 from generating an unintended driving force.

In the present embodiment, the process shown in FIG. 6 is described as being executed by the vehicle control ECU 18. However, the process shown in FIG. 6 may be executed by the inverter ECU 20.

Furthermore, the present disclosure is not limited to the above-described embodiments, and various modifications and applications are possible without departing from the gist of the present disclosure.

For example, in each of the above embodiments, the electric device driven by the inverter 22 installed in the vehicle 14 is the motor generator 30, but the present disclosure is not limited thereto. For example, the electric device driven by the inverter 22 in the vehicle 14 may be a motor that drives the tires of the vehicle 14, a motor that drives a compressor for an inverter of an air conditioner, or a motor that serves as a power source for air mobility (aircraft) or a ship. Further, in each of the above embodiments, the mobile object is the vehicle 14, but the present disclosure is not limited to this. For example, the mobile object may be air mobility or a ship. In addition, in each of the above embodiments, the power converter is described as the inverter 22 for driving the vehicle 14, but the power converter is not limited to this. For example, the power converter may be an inverter for an air conditioner, a DC-DC converter, a rapid charger, or a normal charger.

In addition, the configuration of the vehicle control system 10 described in the above embodiments (see FIGS. 1 and 5) is one example, and it goes without saying that unnecessary parts may be deleted or new parts may be added without departing from the scope of the present disclosure.

Further, the process flows of the vehicle control program 42A (see FIGS. 3, 4, and 6) described in the above embodiment are only examples, and unnecessary steps may be deleted, new steps may be added, or the processing order may be changed without departing from the scope of the present disclosure.

The control circuit and the method thereof which have been described in the present disclosure may be also implemented by a special purpose computer which includes a processor programmed to execute one or more functions implemented by a computer program. Alternatively, the controller and the method described in the present disclosure may be implemented by a special purpose computer configured as a processor with a special purpose hardware logic circuit. Alternatively, the device and its method according to the present disclosure may be implemented by one or more dedicated computers including a combination of a processor executing a computer program and one or more hardware logic circuits. Furthermore, the computer program may be stored in a computer-readable non-transitory tangible storage medium as an instruction executed by a computer.

(Additional Notes) (Appendix 1) A mobile object control device includes a controller configured to execute an installation or activation of a power converter program for controlling a power converter that is installed in a mobile object. The controller is configured to execute the installation or activation of the power converter program in a state where input voltage is not applied to an electric device that is driven by the power converter.

(Appendix 2) According to the mobile object control device of appendix 1, the controller is configured to execute the installation or activation of the power converter program in a state where input voltage is not applied to the power converter, which is the state where the input voltage is not applied to the electric device.

(Appendix 3) According to the mobile object control device of appendix 2, the controller is configured to interrupt the input voltage to the power converter and then execute the installation or activation of the power converter program.

(Appendix 4) According to the mobile object control device of appendix 1, the power converter includes a switching element. The controller is configured to execute the installation or activation of the power converter program in a state where the switching element is not able to be driven.

(Appendix 5) According to the mobile object control device of appendix 4, the switching element is driven by a drive circuit. The controller is configured to stop power supply to the drive circuit and then execute the installation or activation of the power converter program.

(Appendix 6) The mobile object control device of appendix 4 includes a stopping unit configured to stop an output of a drive signal that drives the switching element to a drive circuit. The controller is configured to execute the installation or activation of the power converter program in a state where an output of the drive signal to the drive circuit is stopped by the stopping unit.

(Appendix 7) The mobile object control device of appendix 1 includes an interrupting unit configured to interrupt a power path from the power converter to the electric device. The controller is configured to execute the installation or activation of the power converter program in a state where power supply from the power converter to the electric device is interrupted by the interrupting unit.

(Appendix 8) According to the mobile object control device of any one of appendixes 1 to 7, the controller is further configured to drive the power converter by receiving a drive instruction from a higher-level controller (18), and notify the higher-level controller that the controller does not accept the drive instruction during the installation or activation of the power converter program.

(Appendix 9) A mobile object control method executed by at least one processor (40A) for installing or activating a power converter program for a power converter in a mobile object is provided. The mobile object control method includes executing an installation or activation of the power converter program in a state where input voltage is not applied to an electric device that is driven by the power converter.

(Appendix 10) A mobile object control program for installing or activation a power converter program for a power converter in a mobile object is provided. The mobile object control program is configured to cause at least one processor to execute an installation or activation of the power converter program in a state where input voltage is not applied to an electric device that is driven by the power converter.

1. A mobile object control device comprising
a controller configured to:
receive an instruction to execute an installation or activation of a power converter program for controlling a power converter that is installed in a mobile object;
execute the installation or activation of the power converter program based on the instruction when input voltage is not applied to an electric device that is driven by the power converter; and
stop power supply to the electric device and then execute the installation or activation of the power converter program based on the instruction when the input voltage is applied to the electric device.

2. The mobile object control device according to claim 1, wherein
the controller is configured to execute the installation or activation of the power converter program when the input voltage is not applied to the power converter.

3. The mobile object control device according to claim 2, wherein
the controller is configured to interrupt the input voltage to the power converter and then execute the installation or activation of the power converter program when the input voltage is applied to the power converter.

4. The mobile object control device according to claim 1, wherein
the power converter includes a switching element,
the switching element is driven by a drive circuit, and
the controller is configured to execute the installation or activation of the power converter program based on the drive circuit being unable to drive the switching element.

5. The mobile object control device according to claim 4, wherein
the controller is configured to stop power supply to the drive circuit and then execute the installation or activation of the power converter program based on the drive circuit being able to drive the switching element.

6. The mobile object control device according to claim 4, wherein
the switching element is driven by the drive circuit receiving a drive signal, and
the controller is configured to stop an output of the drive signal to the drive circuit and then execute the installation or activation of the power converter program based on the drive circuit being able to drive the switching element.

7. The mobile object control device according to claim 1, wherein
the controller is configured to interrupt a power path from the power converter to the electric device to interrupt power supply from the power converter to the electric device and then execute the installation or activation of the power converter program.

8. The mobile object control device according to claim 1, wherein
the controller is further configured to:
drive the power converter upon receiving a drive instruction from a higher-level controller; and
notify the higher-level controller that the controller does not accept the drive instruction during the installation or activation of the power converter program.

9. A mobile object control method executed by at least one processor for installing or activating a power converter program for a power converter in a mobile object, the mobile object control method comprising:
receiving an instruction to execute an installation or activation of the power converter program;
executing the installation or activation of the power converter program based on the instruction when input voltage is not applied to an electric device that is driven by the power converter; and
stopping power supply to the electric device and then executing the installation or activation of the power converter program based on the instruction when the input voltage is applied to the electric device.

10. A non-transitory computer-readable storage medium comprising a mobile object control program for installing or activating a power converter program for a power converter in a mobile object, the mobile object control program being configured to cause at least one processor to:
receive an instruction to execute an installation or activation of the power converter program;
execute the installation or activation of the power converter program based on the instruction when input voltage is not applied to an electric device that is driven by the power converter; and
stop power supply to the electric device and then execute the installation or activation of the power converter program based on the instruction when the input voltage is applied to the electric device.
